(19) United States
(12) Patent Application Publication
(10) Pub. No.: US 2026/0098120 A1
(43) Pub. Date: Apr. 9, 2026

(54) IMIDE-CONTAINING POLYOLS, METHODS FOR MAKING IMIDE-CONTAINING POLYOLS AND METHODS FOR USING IMIDE-CONTAINING POLYOLS

(71) Applicant: Dow Global Technologies LLC, Midland, MI (US)

(72) Inventors: Weijun Zhou, Sugarland, TX (US); William J. Harris, Lake Jackson, TX (US)

(21) Appl. No.: 19/114,014

(22) PCT Filed: Oct. 25, 2023
(86) PCT No.: PCT/US2023/035861

§ 371 Date: Mar. 21, 2025

Related U.S. Application Data
(60) Provisional application No. 63/419,008, filed on Oct. 25, 2022.

(51) Int. Cl. C08G 18/64; C08G 18/46; C08G 63/685; C08G 63/78; C08G 73/16; C08J 9/00; C08J 9/14; C08K 5/521

(52) U.S. Cl. CPC C08G 18/6438; C08G 18/4646; C08G 63/6856; C08G 63/78; C08G 73/16; C08J 9/0038; C08J 9/141; C08K 5/521; C08G 2110/0025; C08J 2203/14; C08J 2205/10; C08J 2375/06

(57) ABSTRACT

Embodiments of the present disclosure are directed towards imide-containing polyols, methods for making imide-containing polyols, and methods for using imide-containing polyols.

### FIELD OF DISCLOSURE

This disclosure relates to imide-containing polyols and methods for making and using them.

### BACKGROUND

Rigid polyurethane and polyisocyanurate foam is used as thermal insulation material in buildings, vehicles and appliances, among others. Foam of this type is made by reacting a foam formulation that includes one or more isocyanates, one or more polyols, and one or more blowing agents.

### SUMMARY

The present disclosure provides various embodiments, including the following. A method of making an imide-modified polyol composition, the method comprising: a) forming one or more imide group-containing compounds having terminal carboxylic acid groups by reacting trimellitic anhydride with an aliphatic diamine in the presence of 0 to 3 parts by weight of another carboxylic acid anhydride and/or a polycarboxylic acid per 100 parts by weight of the trimellitic anhydride; b) optionally combining the one or more imide group-containing compounds having terminal carboxylic acid groups with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters, wherein the mole ratio of the imide group-containing compounds and the aromatic dicarboxylic acid derivatives is at least 25:75; c) esterifying the one or more imide group-containing compounds having terminal carboxylic acid groups and the one or more aromatic carboxylic acid derivatives if present by reaction with one or more polyols having a hydroxyl equivalent weight of 30 to 500 g/equivalent, wherein the imide-modified polyol composition has an acid number of no greater than 5 mg KOH/gram, has a hydroxyl number of 100 to 350 mg KOH/g and contains 0.65 to 2.30 moles of imide groups per kilogram of imide-modified polyol composition.

### DETAILED DESCRIPTION

With the growth of global consumption of energy, there is a strong need from end users of foam products with better thermal insulation performance and that is easy to process and fabricate. This has been increasingly difficult to achieve for the industry.

Additionally, many polyurethane and polyisocyanurate foams are often required to be fire resistant and need to use a large amount of halogenated flame retardants, which are coming under regulatory pressure in a number of jurisdictions. Thus, there is a desire to reduce or even eliminate the use of these halogenated materials while maintaining the desired fire resistance in the foam. Taken together, it would be advantageous to prepare a foam product with both enhanced thermal insulation and good fire resistance.

One or more embodiments provide a method of making an imide-modified polyol composition, comprising: a) forming one or more imide group-containing compounds having terminal carboxylic acid groups by reacting trimellitic anhydride with an aliphatic diamine in the presence of 0 to 3 parts by weight of another carboxylic acid anhydride and/or a polycarboxylic acid per 100 parts by weight of the trimellitic anhydride; b) optionally combining the one or more imide group-containing compounds having terminal carboxylic acid groups with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters, wherein the mole ratio of the imide group-containing compounds and the aromatic dicarboxylic acid derivatives is at least 25:75; c) then esterifying the one or more imide group-containing compounds having terminal carboxylic acid groups and the one or more aromatic carboxylic acid derivatives if present by reaction with one or more polyols having a hydroxyl equivalent weight of 30 to 500 g/equivalent to produce an imide-modified polyol composition, wherein the imide-modified polyol composition has an acid number of no greater than 5 mg KOH/gram, has a hydroxyl number of 100 to 350 mg KOH/g and contains 0.65 to 2.30 moles of imide groups per kilogram of imide-modified polyol composition.

One or more embodiments provide an imide-modified polyol composition produced in the foregoing process.

One or more embodiments provide a method for preparing a rigid isocyanate-based foam. One or more embodiments provide forming a reaction mixture and reacting the reaction mixture to produce the rigid isocyanate-based foam, wherein the reaction mixture comprises: a) at least one aromatic polyisocyanate in an amount to provide an isocyanate index of 100 to 600; b) polyols, wherein the polyols include at least 25% by weight of the imide-modified polyol composition as discussed herein and 0 to 75% by weight of one or more non-imide-modified polyols, and wherein the imide content of the polyols is 0.125 to 1.75 moles of imide groups per kilogram; c) at least one blowing agent; d) at least one halogenated and/or phosphorus-containing flame retardant; e) at least one foam-stabilizing surfactant; and f) at least one urethane and/or isocyanate trimerization catalyst.

The imide-modified polyol composition is made by a process that includes a step of forming an imide group-containing compound having terminal carboxylic acid groups. This is accomplished by reacting trimellitic anhydride with an aliphatic diamine.

The aliphatic diamine can have two primary amino group. The aliphatic diamine can be a linear aliphatic diamine, a branched aliphatic diamine, a cyclic aliphatic diamine, or a heteroaliphatic diamine as well as their mixtures. The heteroaliphatic diamine has heteroatoms, such as oxygen, sulfur, and nitrogen, interspersed between alkylene groups with the primary amino group attached to an alkylene group. The aliphatic diamine lacks carboxylic acid groups can also lack other groups (other than the amino groups) that are reactive with a carboxylic acid, amine or hydroxyl group under the conditions of the reaction(s) that produce the imide-modified polyol composition. One or more embodiments provide that the aliphatic diamine can be selected from 4,4′-methylenebis-cyclohexanamine, 2,2′-[oxybis(2,1-ethanediyloxy)]bis-ethanamine, 2,2′-oxybis-ethanamine, 3,3′-[oxybis(2,1-ethanediyloxy)]bis-1-propanamine, 1,4-butanediamine, 1,5-pentanediamine, 1,3-pentanediamine, 1,6-hexanediamine, 1,7-heptanediamine, 1,8-octanediamine, 1,10-decanediamine, 1,11-undecancdiamine, 1,12-doedecandiamine, 1,2-propanediamine, 2-methyl-1,3-propanediamine, 1,3-propanediamine, 1,3-cyclohexanediamine, 1,4-cyclohexanediamine, 3,3′-[1,4-butanediylbis(oxy)]bis-1-propanamine, 1,4-cyclohexanedimethanamine, 1,2-ethanediamine (which may also be referred to as ethylene diamine (ED)), 2,2′-(ethylenedioxy)bis(ethylamine) (which may also be referred to as 1,2-bis(2-aminoethoxy)ethane or diaminotriethylene glycol (DATEG)), 3,3′-[1,2-ethanediylbis(oxy)]bis-1-propanamine (which may also be referred to as ethylene glycol bis(3-aminopropy)ether (EGAPE)), α-(2-aminomethylethyl)-ω-(2-aminomethylethoxy)-poly[oxy(methyl-1,2-ethanediyl)](which may also be referred to as polypropylene glycol diamine or polyoxypropylenediamine or the commercial name JEFFAMINE D230), 2-methyl-1,5-pentanediamine (which may also be referred to as 2-methyl-1,5-diaminopentane (DYTEKA)), 1,3-cyclohexanedimethanamine (which may also be referred to as 1,3-bis(aminomethyl)cyclohexane (1,3-CHDMA)), 1,2-cyclohexanediamine (which may also be referred to as 1,2-diaminocyclohexane (1,2-CHDA)), 5-amino-1,3,3-trimethyl-cyclohexanemethanamine (which may also be referred to as isophoronediamine (IPDA)), including conformational and positional isomers, or combinations thereof. One or more embodiments provide that the aliphatic diamine can be selected from 1,2-ethanediamine (which may also be referred to as ethylene diamine (ED)), 2,2′-(ethylenedioxy)bis(ethylamine) (which may also be referred to as 1,2-bis(2-aminoethoxy)ethane or diaminotriethylene glycol (DATEG)), 3,3′-[1,2-ethanediylbis(oxy)]bis-1-propanamine (which may also be referred to as ethylene glycol bis(3-aminopropy)ether (EGAPE)), α-(2-aminomethylethyl)-ω-(2-aminomethylethoxy)-poly[oxy(methyl-1,2-ethanediyl)](which may also be referred to as polypropylene glycol diamine or polyoxypropylenediamine or the commercial name JEFFAMINE D230), 2-methyl-1,5-pentanediamine (which may also be referred to as 2-methyl-1,5-diaminopentane (DYTEK A)), 1,3-cyclohexanedimethanamine (which may also be referred to as 1,3-bis(aminomethyl)cyclohexane (1,3-CHDMA)), 1,2-cyclohexanediamine (which may also be referred to as 1,2-diaminocyclohexane (1,2-CHDA)), 5-amino-1,3,3-trimethyl-cyclohexanemethanamine (which may also be referred to as isophoronediamine (IPDA)), including conformational and positional isomers, or combinations thereof.

The imidization reaction is performed in the presence of at most 3 parts, at most 2 parts, or at most 1 part by weight of another carboxylic acid anhydride and/or a polycarboxylic acid, per 100 parts by weight of the trimellitic anhydride. Such other carboxylic acid anhydride or polycarboxylic acid, if present at all, may be for example an impurity in the trimellitic anhydride. The other carboxylic acid anhydride and/or polycarboxylic acid may be absent. The near- or total absence of the other carboxylic acid anhydride and/or polycarboxylic acid can allow for a more defined, predictable product to be produced in the imidization reaction.

The trimellitic anhydride and aliphatic diamine can be combined in a ratio that provides 0.8 to 1.2, 0.9 to 1.1, or 0.95 to 1.05 equivalents of anhydride groups per equivalent of amine groups. One or more embodiments provide that the ratio is 0.98 to 1.02 or 0.99 to 1.01 anhydride equivalents per equivalent of amine groups.

The trimellitic anhydride reacts with the amine group of the aliphatic diamine to form an amic acid intermediate that is subsequently ring-closed/dehydrated by chemical and/or thermal means to form a diimide structure (e.g., an aromatic-aliphatic diimide) with the evolution of water. The diimide structure can be represented by Structure (I), wherein Aliph represents an aliphatic group.

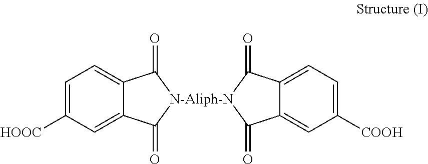

The diimide contains two imide groups and likewise contributes two imide groups to the imide-modified polyol composition as discussed herein.

The aliphatic group can be a linear alkylene with 2 to 18 carbon atoms; a branched alkylene with 3 to 18 carbon atoms; an alicyclic compound with at least one ring and no more than three rings with independent ring sizes of 4 to 8 carbon atoms; a heteroaliphatic alkylene of the form —(CRR¹)ₙ—[Z—(CR²R³)_{n′}]_{n″}—Z—(CRR¹)ₙ— where each R, R¹, R², R³, are independently H or a C1 to C6 alkyl group, n and n′ are independent integers from 2 to 4, n″ is an integer from 0 to 18, each Z is independently a heteroatom; and mixtures thereof. One or more embodiments provide that the aliphatic group can be 1,2-ethane, 1,2-cyclohexane, 2-methyl-1,5-pentane, 1,3-dimethylenecyclohexane, 1,3,3-trimethylcyclohexanemethylene, poly(oxypropylene) with up to 4 repeat units on average, 1,2-diethoxyethane, and 1,2-dipropoxyethane. The imidization reaction can be performed at a temperature of 20° C. to 180° C., for example. Various pressures can be utilized (e.g., sufficient to prevent the reactants from boiling off). Temperature and pressure conditions that permit water evolving in the imidization reaction to evaporate or distill (including azeotropic distillation) and be removed as the reaction proceeds are preferred for a number of embodiments. Passing an inert sweeping gas through the reaction vessel to remove water and/or water-containing azeotrope may also be performed.

The imidization reaction may be performed in a suitable solvent for the trimellitic anhydride and aliphatic diamine. In some embodiments, the solvent is not reactive with any of the starting materials or the reaction product. Examples of such non-reactive solvents include, for example, N,N-dimethylacetamide, N-methylpyrrolidinone, N,N-dimethylformamide, toluene, xylenes, benzene, various C6-C24 hydrocarbons, their mixtures, and the like. The reaction may be performed under reflux conditions for such a non-reactive solvent(s), when used. The imide group-containing compound having terminal carboxylic acid groups produced in the imidization may be isolated from the non-reactive solvent(s) and dried.

Alternatively, the imidization reaction may be performed in the presence of the polyol(s) having a hydroxyl equivalent weight of 30 to 500 g/equivalent, in which case the polyol(s) can function as a solvent and/or reaction medium. When polyol(s) are utilized, the imidization reaction can be performed in the absence of an effective amount of an esterification catalyst, i.e., a catalyst for the reaction of an alcohol with a carboxylic acid. In the absence of such a catalyst, little or no esterification of the terminal carboxyl groups occurs during the imidization step. Although the imide group-containing product may be isolated from the polyol(s) and dried, it is generally preferred not to do so, leaving the imide group-containing product in the polyol(s).

The diimide having terminal carboxylic acid groups obtained in the imidization step is then esterified by reaction with the polyol(s) have a hydroxyl equivalent weight of 30 to 500 g/equivalent. The polyol(s) may be in or include any polyol(s) present during the imidization reaction. Preferably, at least one polyol having a hydroxyl equivalent weight of at least 95 and up to 500 g/equivalent, for example 95 to 400, 95 to 350 or 150 to 250 g/equivalent, is reacted with the diimide having terminal carboxylic acid groups. Such a polyol having a hydroxyl equivalent weight of at least 95 up to 500 in some embodiments constitutes at least 50%, at least 75%, at least 90%, or 100% of the total weight of the polyol(s) having hydroxyl equivalent weights of 30 to 500 g/equivalent. In other words, the polyol having the hydroxyl equivalent weight of at least 95 up to 500 may be from a lower limit of 50%, 75% or 90% to an upper limit of 100%, 99%, or 95% of the total weight of the polyol(s) having hydroxyl equivalent weights of 30 to 500 g/equivalent. The polyol having a hydroxyl equivalent weight of at least 95 up to 500 preferably is difunctional and preferably is a polyether, especially polyethylene glycol, poly(propylene glycol) or an ethylene oxide/propylene oxide copolymer diol. Other useful polyols include diols such as ethylene glycol, diethylene glycol, triethylene glycol, 1,2-propane diol, 1,3-propane diol, dipropylene glycol, tripropylene glycol, cyclohexane dimethanol, neopentyl glycol and the like. Polyols having 3 or more hydroxyl groups can form all or part of the polyols having an equivalent weight of 30 to 500, but if used can constitute a small proportion thereof, such as up to 20%, up to 10% or up to 5% by weight, to avoid excessive branching and/or crosslinking, for instance. Examples of such polyols include glycerin, trimethylolpropane, trimethylolethane, pentaerythritol, erythritol, triethanolamine, and polyethers having 3 to 6 hydroxyl groups per molecule and an equivalent weight of, for example 100 to 500 g/equivalent.

Optionally, in one or more embodiments, the imide group-containing compound(s) having terminal carboxylic acid groups are combined with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters, and the esterification step is performed simultaneously on the resulting mixture. This aromatic dicarboxylic acid derivative contains no imide groups and preferably has a formula molecular weight of no greater than 250 g/mol. Examples of such aromatic dicarboxylic acid derivatives include phthalic anhydride, phthalic acid, isophthalic acid, terephthalic acid, dimethyl terephthalate, dimethyl isophthalate, dimethyl phthalate, terephthaloyl chloride, isophthaloyl chloride, phthaloyl chloride, and the like; and mixtures of any two or more thereof. Preferred aromatic dicarboxylic acid derivatives are phthalic anhydride, phthalic acid, isophthalic acid, and especially phthalic anhydride. In such embodiments, the mole ratio of the diimide to the aromatic dicarboxylic acid derivative is at least 25:75 and may be any higher ratio up to 99.99:0.01. Examples of suitable ratios are at least 30:70 or at least 50:50. In specific embodiments this ratio may be up to 95:5, up to 90:10, up to 80:20 or up to 70:30.

Alternatively, the imide group-containing compound having terminal carboxylic acid groups can undergo the esterification step in the absence of an added aromatic dicarboxylic acid derivative to produce an imide-modified polyol. Some of the starting polyol(s) may remain unreacted during this step. In such embodiments, an aromatic dicarboxylic acid derivative can subsequently be added and the resulting mixture subjected to esterification and/or transesterification conditions to produce an imide group-containing polyol composition as discussed herein.

The ratio of polyol(s) to the imidized reaction product can be selected to provide 1.5 to 3 equivalents of hydroxyl groups per equivalent of carboxyl groups provided by the diimide, plus the carboxyl groups provided by aromatic dicarboxylic acid derivative, if any. For purposes of this calculation, an anhydride group is counted as two carboxylic acid groups, and carboxylic acid alkyl ester and halide groups are each counted as one carboxylic acid group. The equivalent ratio can be at least 1.6, at least 1.75 or at least 1.9 and up to 2.5, up to 2.25, up to 2.10 or up to 2.05. When the equivalent ratio is greater than about 2, a portion of the polyol can remain unreacted during the esterification step.

The esterification reaction can be performed in the presence of an esterification catalyst. Examples of esterification catalysts include Bronsted acid such as sulfuric acid, p-tolunesulfonic acid; Lewis acids such as SnCl4, AlCl3 and BF3, tin(II) compounds such as SnCl2, and various tin dicarboxylates; organotin(IV) compounds such as dialkyltinoxide, dialkyltindicarboxylates and the like, pyrone coordination Sn(II), Pb(II), Zn(II) and/or Hg(II) complexes, and various titanium compounds such as titanium acetylacetonate, titanium(IV)oxyacetylacetonate, titanium diisopropoxidebis)acetylacetonate, tetraisopropyltitanium, triethanolamine titanate, titanium (IV) isobutoxide, as well as other organotitanium and organozirconium catalysts as described in U.S. Pat. No. 3,056,818. Other examples of catalysts useful in the present disclosure are described, for instance, in U.S. Pat. No. 10,619,000. The catalyst is used in a catalytically effective amount, such as from 10 to 10,000 parts by weight per million parts of the combined weights of the diimide, polyol(s) and any added aromatic dicarboxylic acid derivative.

The esterification reaction can be performed at a temperature from 100° C. to 270° C. One or more embodiments provide that the temperature is at least 180° C., at least 200° C. or at least 220° C. Various pressures can be utilized, the pressure being generally sufficient to prevent the reactants from boiling off, but, temperature and pressure conditions that permit water and other volatile by-products of the esterification reaction to evaporate or distill and be removed as a vapor as the reaction proceeds may be preferred. One or more embodiments provide that the pressure is approximately atmospheric pressure, such as about 90 to 110 kPa. Subatmospheric pressures less than atmospheric pressure from as low as 1 kilopascal can be used. The esterification reaction may be performed in a suitable solvent for the starting materials, such as those described above with respect to the imidization reaction. The reaction may be performed under reflux conditions for the solvent, when used, but it is preferred to perform the esterification reaction in the absence of any solvent apart from the reactants. The reaction can be continued until the acid number is reduced to less than less than 5 mg KOH/g, 2 mg KOH/g, less than 1 mg KOH/g, or less than 0.5 mg KOH/g, as measured by the potentiometric titration with a standardized 0.01 N potassium hydroxide solution. One or more embodiments provide that the acid number has a lower of limit of 0.001 mg KOH/g, or 0.01 mg KOH/g. If a portion of the polyol(s) volatilize, it can be replenished by adding a corresponding amount of additional polyol(s) optionally followed by additional reaction under transesterification conditions.

The resulting imide-modified polyol composition includes one or more hydroxyl-terminated, ester-containing reaction products of the imide group-containing compound and the polyol(s). When an aromatic dicarboxylic acid derivative is present during all or part of the esterification step, the composition also contains one or more hydroxyl-terminated ester-containing reaction products of the aromatic dicarboxylic acid derivative and the polyol(s). The imide-modified polyol composition may contain some amount of unreacted starting polyol(s). The imide-modified polyol composition has a hydroxyl number of 100 to 350 mg KOH/g, 125 to 300 mg KOH/g, or 150 to 275 mg KOH/g, as measured according to ASTM E1899-16. It contains 0.65 to 2.30 moles of imide groups per kilogram of imide-modified polyol composition. In some embodiments the imide-modified polyol composition contains at least 0.75 or at least 1.00 moles of imide groups per kilogram, and in specific embodiments contains at most 2.2 or at most 2.0 moles of imide groups per kilogram. An imide-containing compound made by reacting two moles of trimellitic anhydride with a mole of an aliphatic diamine produces two moles of imide groups.

The imide-modified polyol composition may have an average hydroxyl functionality in the range from 1.8 to 4, preferably 1.8 to 3, more preferably 1.8 to 2.5, or 1.8 to 2.2. One or more embodiments provide that the imide-modified polyol composition is a liquid at room temperature. In some instances, some crystals may form upon prolonged standing at room temperature; these crystals typically disappear upon heating the imide-modified polyol composition. The imide-modified polyol composition may exhibit a viscosity of, for example, of 1 to 300 Pa·s, 5 to 150, or 5 to 100 Pa·s, as measured according to ISO3219 at 25° C. and a shear rate of 10 sec-1. If crystals have formed in the imide-modified polyol composition, viscosity is measured by heating the composition to 70° C. to melt the crystals, cooling to 25° C. within 4 hours, and then determining viscosity.

The glass transition temperature (Tg) of the imide-modified polyol composition may be, for example, −10 to −80° C., or −25 to −65° C., as measured according to ASTM E1356-08(2014), taking the midpoint temperature as the Tg.

The imide-modified polyol composition is useful for making isocyanate-based polymers, for instance. The isocyanate-based polymers contain urethane groups produced in a reaction of hydroxyl groups of the imide-modified polyol composition with isocyanate groups of a polyisocyanate. The isocyanate-based polymer may further contain other groups formed in a reaction of an isocyanate group, such as urea, isocyanurate, biuret, allophanate, carbodiimide and like groups. Some polymers are polyurethane-isocyanurate polymers, particularly foams, that contain urethane and isocyanurate groups. Isocyanurate groups are formed in a trimerization reaction of three isocyanate groups.

Rigid isocyanate-based foam is made by forming a reaction mixture and reacting the reaction mixture to produce the rigid isocyanate-based foam. The reaction mixture comprises the imide-modified polyol composition discussed herein and at least one aromatic polyisocyanate. The aromatic polyisocyanate is provided in an amount to provide an isocyanate index of 100 to 600. Isocyanate index is 100 times the ratio of isocyanate groups to isocyanate-reactive groups (hydroxyl, primary or secondary amino, carboxylic acid, water, etc.) provided to the reaction mixture. For purposes of calculating isocyanate index, water is considered as having two isocyanate-reactive groups. The isocyanate index in some embodiments is at least 125, at least 150, or at least 180.

The polyisocyanate may have an isocyanate equivalent weight of up to 300 g/equivalent, for example. The isocyanate equivalent weight may be up to 250, up to 175, and in some embodiments is 80 to 175 g/equivalent. If a mixture of polyisocyanate compounds is used, these equivalent weights apply with respect to the mixture; individual polyisocyanate compounds in such a mixture may have isocyanate equivalent weights above, within or below those ranges.

Examples of polyisocyanates include m-phenylene diisocyanate, toluene-2,4-diisocyanate, toluene-2,6-diisocyanate, hexamethylene-1,6-diisocyanate, tetramethylene-1,4-diisocyanate, cyclohexane-1,4-diisocyanate, hexahydrotoluene diisocyanate, naphthylene-1,5-diisocyanate, 1,3- and/or 1,4-bis(isocyanatomethyl)cyclohexane (including cis- and/or trans isomers), methoxyphenyl-2,4-diisocyanate, diphenylmethane-4,4′-diisocyanate, diphenylmethane-2,4′-diisocyanate, hydrogenated diphenylmethane-4,4′-diisocyanate, hydrogenated diphenylmethane-2,4′-diisocyanate, 4,4′-biphenylene diisocyanate, 3,3′-dimethoxy-4,4′-biphenyl diisocyanate, 3,3′-dimethyl-4-4′-biphenyl diisocyanate, 3,3′-dimethyldiphenyl methane-4,4′-diisocyanate, 4,4′,4″-triphenyl methane triisocyanate, polymethylene polyphenylisocyanate (PMDI), toluene-2,4,6-triisocyanate and 4,4′-dimethyldiphenylmethane-2,2′,5,5′-tetraisocyanate. Preferably the polyisocyanate is diphenylmethane-4,4′-diisocyanate, diphenylmethane-2,4′-diisocyanate, PMDI, toluene-2,4-diisocyanate, toluene-2,6-diisocyanate or mixtures thereof. Diphenylmethane-4,4′-diisocyanate, diphenylmethane-2,4′-diisocyanate and mixtures thereof are generically referred to as MDI, and all can be used. “Polymeric MDI”, which is a mixture of PMDI and MDI, can be used. Toluene-2,4-diisocyanate, toluene-2,6-diisocyanate and mixtures thereof are generically referred to as TDI, and all can be used.

The imide-modified polyol composition of the present disclosure constitutes at least 25%, or at least 50% by weight of the polyols present in the foam-forming reaction mixture. In some embodiments, the imide-modified polyol composition constitutes at least 60% or at least 70% of the total weight of all polyols. It may constitute up to 100%, up to 95%, up to 90% or up to 80% of the total weight of all polyols. The polyols in the foam-forming reaction mixture optionally contains one or more non-imide-modified polyols, provided the imide content of the polyols is 0.125 to 1.75 moles, especially 0.15 to 1.75 moles or 0.30 to 1.50 moles of imide groups per kilogram of the combined weight of all polyols. The non-imide-modified polyol(s), if present, may constitute, for example, 1 to 75%, 1 to 50%, 1 to 40%, 1 to 30%, 1 to 20%, 1 to 10% or 1 to 5% of the total weight of all polyols (including the imide-modified polyol composition of the present disclosure).

The non-imide-modified polyol(s) for the foam-forming reaction mixture of the present disclosure may have, for example, an average nominal hydroxyl functionality in the range 1.8 to 8, 1.8 to 6.0, 1.8 to 4.5, or 1.8 to 3.0, and an average hydroxyl number of 75 mg to 750 mg KOH/g.

Non-imide-modified polyols, if present, may include, for example, chain extenders, i.e., compounds that react difunctionally with isocyanate groups and have equivalent weights per isocyanate-reactive group of less than 200, such as 30 to 125. Examples of chain extenders include ethylene glycol, diethylene glycol, triethylene glycol, propylene glycol, dipropylene glycol, tripropylene glycol, 1,4-butanediol, 1,6-hexanediol, ethylene diamine, propylene diamine, and the like.

Other non-imide-modified polyols may include crosslinkers, i.e., compounds that have three or more isocyanate-reactive groups and equivalent weights per isocyanate-reactive group of less than 200, such as 30 to 125. Examples of crosslinkers include glycerin, trimethylolpropane, triethylolpropane, pentaerythritol, erythritol, triethanolamine, diethanolamine, mannitol, sucrose, urea, sorbitol and the like.

Other non-imide-modified polyols include polyether polyols having an equivalent weight per isocyanate-reactive group of greater than 75 g/equivalent. The equivalent weight may be, for example, up to 2000, up to 1000, up to 500, up to 400 or up to 300 g/equivalent. These polyols may have an average of 2 to 8, 2 to 4 or 2.5 to 4 isocyanate-reactive groups per molecule. Polyether polyols include, for example, homopolymers of propylene oxide and random polymers of at least 70 mole-% propylene oxide and up to 30 mole-% ethylene oxide, and homopolymers of ethylene oxide, random and/or block copolymers of at least 50 mole-% ethylene oxide at least and up to 50 mole-% of propylene oxide and/or butylene oxide.

Still other non-imide-modified polyols include polyester polyols and polycarbonate polyols. Non-imide-modified polyols when present can include at least one aromatic polyester polyol not present in the imide-modified polyol composition of the present disclosure. Such an aromatic polyester polyol may have a hydroxyl equivalent weight of, for example, 150 to 400 g/equivalent and a hydroxyl functionality of 2 to 3, 2 to 2.7, or 2 to 2.5. When present, such other aromatic polyester polyol may constitute, for example, at least 5% or at least 10% and up to 75%, up to 35% or up to 25% of the total weight of all polyols utilized.

The polyols present in the foam-forming reaction mixture may contain no more than 45%, no more than 30%, no more than 25%, no more than 15%, or no more than 10% by weight of polyether polyols (other than the imide-modified polyol composition).

In some embodiments, a polyethylene glycol having a number average molecular weight of up to 400 g/mol constitutes 1 to 30% of the total weight of all polyols.

The foam-forming reaction mixture contains at least one blowing agent. The blowing agent may be or include a chemical blowing agent that reacts under the conditions of the foaming reaction to produce a gas. Examples of chemical blowing agents include water and formic acid. In one or more embodiments, the foam-forming reaction mixture contains water in an amount of 0.1 to 3, or 0.2 to 2.5, 0.5 to 2.5, or 0.8 to 2.0 parts by weight per 100 parts of total polyols in the foam-forming reaction mixture.

The blowing agent may be or include one or more physical (endothermic) blowing agents, which can be used alone or in combination with one or more chemical blowing agents (e.g., water). Examples of physical blowing agents include methyl formate, low boiling hydrocarbons (e.g., heptane, hexane, n-pentane, iso-pentane, butane, cyclopentane, cyclohexane, and the like; and mixtures thereof), low boiling ketones such as acetone and methyl ethyl ketone, hydrochlorofluorocarbons (HCFCs) such as 1,1-dichloro-1-fluoroethane, hydrofluorocarbons (HFCs) such as 1,1,1,3,3-pentafluoropropane, hydrofluoroolefins (HFOs) such as trans-1,3,3,3-tetrafluoroprop-1-ene, 1,3,3,3-tetrafluoropropene, and the like; and mixtures thereof. Commercially available hydrofluoroolefin blowing agents include SOLSTICE LBA and SOLSTICE GBA, available from Honeywell; and OPTEON 1100 and OPTEON 1150, available from Chemours. Linear, branched and/or cyclic C4-C6 alkanes such as cyclopentane, isopentane, n-pentane and neopentane are particularly useful. One or more embodiments provide that the physical blowing agent is n-pentane or a cyclopentane/isopentane blend. Physical blowing agent(s), when present, may be in an amount of 0.1 to 40 parts by weight per 100 parts of total polyols in the foam-forming reaction mixture.

The foam-forming reaction mixture contains at least one halogenated and/or phosphorus-containing flame retardant, which preferably is not reactive toward isocyanate groups. Examples of non-reactive phosphorus-containing flame retardants include tris(1-chloropropyl)phosphate, triethylphosphate, resorcinol bis(diphenyl phosphate), triphenyl phosphate, trimethyl phosphate, triphenylphosphine oxide, 9,10-dihydro-9-oxa-10-phosphaphenanthrene-10 oxide and derivative, red phosphorus, inorganic phosphinates, aluminum phosphate, melamine orthophosphate, dimelamine orthophosphate, melamine pyrophosphate, melamine polyphosphate, oligomeric ethyl ethylene phosphate, dimethyl methylphosphonate, diethyl ethylphosphonate, diethyl propylphosphonate, tris (2-chloroethyl) phosphate, cyclic phosphonates, pentaerythrtol phosphonate, cyclic neopentyl thiophosphoric anhydride, metal phosphinic acid salts such as zinc diethyl phosphinate and aluminum diethyl phosphinate, tricresyl phosphate, t-butylphenyl phosphates including t-butylphenyl diphenyl phosphate, 2-ethylhexyl diphenyl phosphate, isodecyl diphenyl phosphate, and various phosphazene compounds. Polymeric or oligomeric phosphorus-containing compounds such as oliogomeric alkyl phosphate ester (e.g., LEVAGARD 2000 and LEVAGARD 3000, from Lanxess) are also suitable. Phosphorus flame retardants containing one or more hydroxyl groups can also be used, for example, LEVAGARD 2100 and LEVAGARD 4090N from Lanxess, FYROL 6 and VERIQUEL R100 from ICL Industrial Products. The halogenated flame retardants can be omitted. When used, the flame retardant may be present in an amount of from 0.1 to 30 parts, 1 to 25 parts, 2 to 25 parts, or 5 to 25 parts, per 100 parts by weight of total polyols amount in the foam-forming reaction mixture.

The foam-forming reaction mixture includes at least one surfactant (e.g., a foam-stabilizing surfactant). The surfactant can help stabilize the gas bubbles formed by the blowing agent during the foaming process until the polymer has cured. Examples of suitable surfactants include silicone-based surfactants such as polysiloxane polyoxylalkylene block copolymers disclosed in U.S. Pat. Nos. 2,834,748; 2,917,480; and 2,846,458; and organic-based surfactants containing polyoxyethylene-polyoxybutylene block copolymers such as those described in U.S. Pat. No. 5,600,019. Examples of such silicone surfactants are commercially available under the trade names TEGOSTAB (Evonik Industries AG), NIAX (Momentive), and VORASURF (The Dow Chemical Company). Specific examples of useful surfactants include VORASURF DC 193, VORASURF RF 5374, VORASURF DC 5604, VORASURF SF 2937, VORASURF DC 5098, VORASURF 504, TEGOSTAB B8418, TEGOSTAB B8491, TEGOSTAB B8421, TEGOSTAB B8461, and TEGOSTAB B8462, NIAX L-6988, NIAX L-6642, and NIAX L-6633 surfactants. The amount of surfactant, when used, may be from 0.1 pts to 10.0 parts per upon 100 parts of total polyols present in the foam-forming reaction mixture.

The foam-forming reaction mixture contains one or more catalysts. The catalysts may include one or more urethane catalysts, which refers to compounds that catalyze either or both of the water-isocyanate reaction and the alcohol-isocyanate reaction. Suitable catalysts include, for example, including tertiary amines, cyclic amidines, tertiary phosphines, various metal chelates, acid metal salts, strong bases, various metal alcoholates and phenolates and metal salts of organic acids. Examples of metal-containing catalysts include tin, bismuth, cobalt and zinc salts. Catalysts include tertiary amine catalysts, cyclic amidines, zinc catalysts, and tin catalysts. Examples of tertiary amine catalysts include: trimethylamine, triethylamine, tributylamine, N-methylmorpholine, N-ethylmorpholine, N,N-dimethylbenzylamine, N,N-dimethylethanolamine, N,N-dimethylaminopropylamine, N,N,N′,N′-tetramethyl-1,4-butanediamine, N,N,N′,N′-tetramethylethylenediamine, N,N,N′,N″,N″-pentamethyldiethylene-triamine, N,N-Dimethylcyclohexylamine, N,N-dimethylpiperazine, 1,4-diazobicyclo-2,2,2-octane, bis(dimethylaminoethyl)ether, triethylenediamine and dimethylalkylamines where the alkyl group contains from 4 to 18 carbon atoms. Mixtures of these tertiary amine catalysts may be used. When used, tertiary amine catalysts may be present, for example, in an amount of from 0.05 to 5 parts per on 100 parts by weight of polyols in the foam-forming reaction mixture.

Examples of metal-containing urethane catalysts include tin(II) salts of organic carboxylic acids such as tin(II) diacetate, tin (II) ricinoleate or tin (II) dioctoate, bismuth salts of organic carboxylic acids such as bismuth octanoate); organotin compounds such as dimethyltin dilaurate, dibutyltin dilaurate, and other tin compounds of the formula SnRn(OR)4-n, wherein R is alkyl or aryl and n is 0 to 18, and the like; dialkyl tin mercaptoates, and the like. Metal-containing urethane catalysts can be used in amounts such as 0.0015 to 0.25 parts by weight per 100 parts total polyols present in the foam-forming reaction mixture.

A reactive amine catalyst, such as DMEA (dimethylethanolamine) or DMAPA (dimethylaminopropyl amine), or an amine-initiated polyol, acting as an autocatalytic polyol, may also be used to reduce VOC's (volatile organic compounds), for instance.

The foam-forming reaction mixture can contain at least one isocyanate trimerization catalyst. The isocyanate trimerization catalyst is a material that promotes the reaction of isocyanate groups with other isocyanate groups to form isocyanurate rings. Useful isocyanate trimerization catalysts include strong bases such as alkali metal phenolates, alkali metal alkoxides, alkali metal hydroxides, alkali metal carboxylates, quaternary ammonium salts and the like. The alkali metal can be sodium or potassium. Specific examples of such trimerization catalysts include sodium p-nonylphenolate, sodium p-octyl phenolate, sodium p-tert-butyl phenolate, sodium acetate, sodium 2-ethylhexanoate, sodium propionate, sodium butyrate, the potassium analogs of any of the foregoing, trimethyl-2-hydroxypropylammonium carboxylate salts, N,N′,N″-tris(3-dimethylaminopropyl)hexahydro-S-triazine, and the like. Examples of commercially available trimerization catalysts include Dabco K15, Polycat 46, TMR 2, TMR 18, etc., available from Evonik, DABCO K2097, among others. The isocyanate trimerization catalyst may be present in a catalytic quantity, such as 0.05 to 10 parts by weight per 100 parts of total polyols present in the foam-forming reaction mixture.

In addition to the foregoing components, the foam formulation may contain various other optional ingredients such as, for example, liquid nucleating additives, solid nucleating agents, Ostwald ripening inhibitor additives, reactive or non-reactive diluents, expandable graphite, pigments, rheological modifiers, emulsifiers, antioxidants, mold release agents, dyes, pigments and/or colorants such as titanium dioxide, iron oxide, chromium oxide, azo/diazo dyes, phthalocyanines, dioxazines and carbon black; fillers or reinforcing agents such as fiber glass, carbon fibers, flaked glass, mica, talc and the like; and mixtures thereof.

Foam can be prepared by combining the polyol(s), blowing agent(s), polyisocyanate(s), surfactant(s), flame retardant(s), and catalysts in the presence of the various optional ingredients (if any) to form a foam-forming reaction mixture. The surfactant, catalysts, flame retardant(s), blowing agent(s) and various polyols all can be mixed together before they are combined with the polyisocyanate. Alternatively, they can be combined with the polyisocyanate individually (i.e., as separate streams), or can be formed into any sub-mixtures that are then combined with the polyisocyanate. The components can be mixed at a temperature from 5 to 80° C. The components may be mixed together using equipment such as a spray apparatus, a low pressure impingent mixer, a high pressure impingent mixer, a static mixer, a liquid dispensing gun or a mixing head, or a stirred vessel, for instance.

The reaction mixture is then reacted to form a foam. The process of this disclosure requires no special processing conditions; therefore, general processing conditions and equipment described in the art for making rigid isocyanate-based foam are entirely suitable. In general, the components of the reaction mixture are combined and the fully mixed foam-forming reactive composition is subjected to conditions sufficient to allow the foaming reaction to occur. In most cases the isocyanate compounds will react spontaneously with the chemical blowing agent (if present) and the polyols even at room temperature (22° C.). If desired, heat can be applied to the reaction mixture to speed the curing reaction. This can be done by heating some or all of the ingredients prior to combining them, by applying heat to the reaction mixture, or some combination of each. The curing temperature may be, for example, from 20° C. to 150° C., or 30° C. to 80° C. Curing can be continued until the reaction mixture has expanded and cured sufficiently to form a stable foam.

In some embodiments, the curing step is performed in a closed mold. In such a process, the reaction mixture is either formed in the mold itself or formed outside the mold and then injected into the mold, where it cures. The expansion of the reaction mixture as it cures is therefore constrained by the internal surfaces of the mold, as are the size and geometry of the molded part.

In one or more embodiments, the curing step is performed in a free-rise (or slabstock) process. In the free-rise process, the reaction mixture is poured into an open container such that expansion in at least one direction (usually the vertical direction) occurs against the atmosphere or a lightweight surface (such as a film) that provides negligible resistance to the expansion of the foam. In the free-rise process, the reaction mixture expands in at least one direction essentially unconstrained except by its own weight. The free-rise process may be performed by forming the reaction mixture and dispensing it into a trough or onto a conveyor where it expands and cures.

In one or more embodiments, the foam-forming reaction mixture is dispensed between facing panels (or atop a single panel), gauged into a layer and cured to form a laminated material. This can be performed, for example, on a double belt laminator or similar equipment. Curing is conveniently performed by passing the facing panel(s) with applied foam-forming reaction mixture layer through an oven which supplies heat to promote curing. This process is useful for producing sandwich panels for the construction or transportation industries.

The cured foam in some embodiments has a foam density of 20 to 200 kg/m3, 25 to 150 kg/m3, or 25 to 100 kg/m3, as measured by ISO 3886.

The cured foam in some embodiments exhibits a smoke density of no more than 60, no more 50, or no more than 40. Generally, a relatively lower smoke density indicates a better fire performance. One or more embodiments provide the smoke density can have a lower limit of 0, 3, or 5, for instance. Smoke density produced upon exposure of each foam sample to a flame was measured at the heat flux of 25 kW/m² using a NBS smoke chamber according to ASTM E 662.

The cured foam in some embodiments exhibits an advantageously low thermal conductivity or k-factor (10° C. average plate temperature). In some embodiments the k-factor is less than or equal to 19.5 mW/m-K, less than or equal to 19.2 mW/m-K, or less than or equal to 19.0 mW/m-K. The cured foam, in some embodiments with a hydrofluoroolefin (HFO) blowing agent such as SOLSTICE LBA, may achieve thermal conductivity of less than or equal to 18.0 mW/m-K, less than or equal to 17.5 mW/m-K, even less than or equal to 17.0 mW/m-K, or even further less than or equal to 16.5 mW/m-K. The rigid isocyanate-based foam of this embodiment can have a thermal conductivity greater than 15.0 mW/m-K. Foams with lower thermal conductivity provide improved insulation performance.

Foam of the present disclosure is useful in various types of thermal insulation applications such as for building and construction use, walk-in cooler, refrigerated transport container, cryogenic storage, and the like applications. The imide-containing polyols can be used to make non-cellular isocyanate-based polymers useful in, for example, coating, adhesive, and electronics, etc.

The following examples are provided for illustration but are not intended to limit the scope. All parts and percentages are by weight unless otherwise indicated.

### EXAMPLES

Example 1-P (EX 1-P), an imide-modified polyol composition, was made as follows. 2,2′-(Ethane-1,2-diyl)bis(1,3-dioxoisoindoline-5-carboxylic acid) was made as follows. 1-Methyl-2-pyrolidinone (240 mL, NMP) and toluene (50 mL to flask, 20 ml to Dean-Stark trap) were added to a container (magnetically stirred, 3-neck, 500 mL roundbottom flask with N2 inlet/outlet, stoppers, and Dean-Stark type trap with condenser); toluene was brought to reflux and collected water was drained from the trap. Trimellitic anhydride (64.04 g, 0.3333 mol) was added to the container in four equal portions over 1.25 hours. Ethylene diamine (10.01 g, 0.1666 mol, EDA) was added to the container dropwise via an attached pressure equalizing addition funnel over 20 minutes under positive N2. The container contents were warmed to 60° C. and maintained for 1 hour. The apparatus was switched to N2 sweep with toluene brought to reflux for 3 hours and collected water drained from the trap, with subsequent removal of bulk of toluene by the trap. The container contents were cooled to approximately 20° C., then chilled in ice water with solid product collected by filtration and product washed 2×150 mL of methanol. Product was dried approximately 12 hours in 80° C. vacuum oven. Product (2,2′-(Ethane-1,2-diyl)bis(1,3-dioxoisoindoline-5-carboxylic acid)) was recrystallized from hot N,N-dimethylacetamide (177 g) with solid product upon cooling collected by filtration and washed with ˜3×50 mL of methanol and dried sequentially in 80° C., then 115° C. vacuum oven to constant weight. Yield=51.4 grams, melting point of 367° C.

Polyethylene glycol 200 (83.77 g, 0.4168 mol), diethylene glycol (7.75 g, 0.0730 mol), phthalic anhydride (18.14 g, 0.1224 mole), and 2,2′-(ethane-1,2-diyl)bis(1,3-dioxoisoindoline-5-carboxylic acid) (50.00 g, 0.1224 mol) were added to a container (4-neck, 500 mL roundbottom flask, N2 inlet adaptor inserted along with overhead stirrer, stoppers in remaining necks). Apparatus was degassed by 3 cycles of N2/vacuum (100 Torr) and kept under N2 sweep with a Dean-Stark type trap and condenser attached to flask exit. The apparatus was insulated, and the flask was warmed from room temperature with stirring over 2 hours to an initial setpoint of 200° C. with TYZOR AA105 (0.0166 g) injected into the flask at 102° C.; the flask was maintained at 200° C. for 1 hour, then warmed to/held at 210° C. for 1 hour, warmed to/held at 220° C. for 6 hours with distillate collected and drained. Dean-Stark type trap and condenser were removed and apparatus was cooled to 200° C. under positive N2 with make-up DEG (6.3 g) added to the flask to compensate for excess distillate and then held at 200/180° C. for 1 hour prior to cooling and transferring. Final product had viscosity, q, of 31.2 Pa·s at 25° C.; GPC molecular weights, Mn of 646, Mw of 1081, and polydispersity index of 1.67; a hydroxyl number, OH #, of 197 mg KOH/gram (theory 180 mg KOH/g); and an acid number, acid #, of 0.15 mg KOH/g; and glass transition, Tg of −39° C.

Example 2-P, an imide-modified polyol composition, was made as follows. Polyethylene glycol 200 (150.53 g, 0.74891 mol), diethylene glycol (13.93 g, 0.1313 mol) and ethylenediamine(13.20 g, 0.2199 mol) were added to a container (4-neck, 500 mL roundbottom flask, N2 inlet adaptor inserted along with overhead stirrer, stoppers in remaining necks). Flask was degassed three times by cycling between 200 Torr and atmospheric pressure of N2. Flask was placed under gentle N2 sweep through a Dean-Stark type trap and condenser attached to flask exit. Apparatus was insulated. Flask was placed under positive N2 and trimellitic anhydride (84.52 g total, 0.4399 mol) was added in three equal mass portions to the stirred flask; the first portion was added at 50° C. and after 20 minutes with mild exotherm, the second portion was added at 57° C. with setpoint raised to 75° C. and after 30 minutes, the third portion was added at 75° C., with setpoint raised to and held at 95° C. and held 1.25 hours. Reaction mixture was then ramped to and held at 140° C. under a gentle N2 sweep and held for 3 hours, reaction mixture was warmed and held at 160° C. for 2 hours with distillate collected. Reaction mixture was cooled to 95° C. with phthalic anhydride (32.60 g, 0.02201 mol) and TYZOR AA105 (0.0860 g) added to the flask. Flask was warmed with stirring over 0.75 hours to a setpoint of 200° C. and held there for 1 hour, then warmed to and held at 210° C. for 1 hour before cooling to room temperature. Flask was rewarmed to 220° C. over 1.5 hours (with additional charge of TYZOR AA105 (0.0489 g) made at 90° C.) and held at 220° C. for 6 hours with distillate collected and drained. Dean-Stark type trap and condenser were removed with apparatus cooled to 200° C. under positive N2 with make-up diethylene glycol (2.25 g) added to the flask to compensate for excess distillate and then held at 200/180° C. for 1 hour prior to cooling and transferring. Final product had viscosity, q, of 43.8 Pa·s at 25° C.; GPC molecular weights, Mn of 677, Mw of 1243, and polydispersity index of 1.84; a hydroxyl number, OH #, of 176 mg KOH/gram (theory 180 mg KOH/g); and an acid number, acid #, of 0.17 mg KOH/g; and glass transition, Tg of −34° C.

Example 3-P, an imide-modified polyol composition, was made as follows. Polyethylene glycol 200 (333.12 g, 1.6573 mol), diethylene glycol (31.04 g, 0.2925 mol), and ethylenediamine (14.63 g, 0.2438 mol) were added to a container (4-neck, 1000 mL roundbottom flask, N2 inlet adaptor inserted along with overhead stirrer, stoppers in remaining necks). Flask was degassed three times by cycling between 200 Torr and atmospheric pressure of N2. Flask was placed under gentle N2 sweep through a Dean-Stark type trap and condenser attached to flask exit. Apparatus was insulated. Flask was placed under positive N2 and trimellitic anhydride (93.65 g Total, 0.4874 mol) was added in three equal mass portions to the stirred flask; the first portion was added at 51° C. and after 25 minutes with mild exotherm, the second portion was added at 56° C. with exotherm and after 20 minutes, the third portion was added at 69° C. with setpoint of 70° C. and after 40 minutes the setpoint is raised to and held at 95° C. over 50 minutes. Reaction mixture was then ramped to and held at 140° C. under a gentle N2 sweep and held for 3 hours, reaction mixture was warmed and held at 160° C. for 1 hour with distillate collected. TYZOR AA105 (0.1079 g) was added to the flask and reaction mixture was warmed and held at 220° C. over 3.5 hours. Reaction mixture was cooled with phthalic anhydride (108.30 g, 0.73115 mol) and TYZOR AA105 (0.1244 g) added to the flask at 96° C. Flask was warmed with stirring over 0.8 hours to a setpoint of 200° C. and held at 200° C. for 1 hour, then warmed to and held at 220° C. for 6.5 hours before cooling to 200° C. with distillate collected and drained. Dean-Stark type trap and condenser were removed with apparatus under positive N2 with make-up diethylene glycol (6.58 g) added to the flask to compensate for excess distillate and then held at 200/180° C. for 1 hour prior to cooling and transferring. Final product had viscosity, q, of 6.54 Pa·s at 25° C.; GPC molecular weights, Mn of 595, Mw of 947, and polydispersity index of 1.59; a hydroxyl number, OH #, of 212 mg KOH/gram (theory 199 mg KOH/g); and an acid number, acid #, of 1.40 mg KOH/g; and glass transition, Tg of −47° C.

Examples 4-P through 13-P, imide-modified polyol compositions, were made in a similar fashion as Example 3-P, with materials indicated in Tables 1-3.

TYZOR AA105 is titanium acetylacetonate (100% active); Dytek A is 2-methyl-1, 5-pentandediamine; JEFFAMINE D230 is polyoxypropylenediamine having nominal molecular weight of 230; 1,3-CHDMA is 1,3-bis(aminomethy)cyclohexane (mixture of cis/trans isomers); 1,2-CHDA is 1,2-diaminocyclohexane (mixture of cis/trans isomers); IDPA is isophoronediamine (mixture of cis/trans isomers); EGAPE is ethylene glycol bis(3-aminopropy)ether.

A number of properties were determined for the imide-modified polyol compositions. Glass transition temperature (Tg) was determined according to ASTM E1356-08, taking the midpoint temperature as Tg. Hydroxyl number was determined according to ASTM E1899-16. Acid number was determined by potentiometric titration with standardized 0.01N potassium hydroxide solution according to ASTM D664-18. Number average molecular weight (Mn), weight average molecular weight (Mw), and polydispersity index (PDI)=Mw/Mn)) were determined according to ASTM 05296-19, utilizing polyethylene glycol calibration standards and uninhibited tetrahydrofuran solvent.

TABLE 1

| | Ex 1-P | Ex 2-P | Ex 3-P | Ex 4-P | Ex 5-P |
|---|---|---|---|---|---|
| Diimide | 50 | 50 | 25 | 75 | 35 |
| dicarboxylic | | | | | |
| acid (mol %) | | | | | |
| Imide content | 1.60 | 1.60 | 0.89 | 2.19 | 1.13 |
| (mol/kg polyol) | | | | | |
| Pre-made | 50.00; 0.1224 | — | — | — | — |
| imide acid | | | | | |
| (g; mol) | | | | | |
| Trimellitic | — | 84.52; 0.4399 | 93.65; 0.4874 | 231.32; 1.2040 | 152.01; 0.7912 |
| anhydride | | | | | |
| (g; mol) | | | | | |
| Ethylene | — | 13.20; 0.2199 | 14.63; 0.2438 | 36.13; 0.6021 | — |
| diamine | | | | | |
| (g; mol) | | | | | |
| 1,2-Bis(2- | — | — | — | — | 58.63; 0.3956 |
| aminoethoxy)ethane | | | | | |
| (g; mol) | | | | | |
| Dytek A | — | — | — | — | — |
| (g; mol) | | | | | |
| Jeffamine D230 | — | — | — | — | — |
| (g; mol) | | | | | |
| Phthalic | 18.14; 0.1224 | 32.60; 0.2201 | 108.30; 0.7312 | 29.71; 0.2006 | 108.82; 0.7347 |
| anhydride | | | | | |
| (g; mol) | | | | | |
| Polyethylene | 83.77; 0.4168 | 150.53; 0.7489 | 333.12; 1.657 | 274.27; 1.3645 | 386.21; 1.9214 |
| glycol 200 | | | | | |
| (g; mol) | | | | | |
| Diethylene | 7.75; 0.0730 | 13.93; 0.1313 | 31.04; 0.2925 | 25.55; 0.2408 | 35.98; 0.3391 |
| glycol | | | | | |
| (g; mol) | | | | | |
| TYZOR AA105 | 0.0166 | 0.0860; 0.0489 | 0.1079; 0.1244 | 0.1263; 0.1244 | 0.1350; 0.1595 |
| (g) | | | | | |
| Make up | 6.30 | 2.25 | 6.58 | 7.97 | 12.0 |
| Diethylene | | | | | |
| glycol (g) | | | | | |

TABLE 2

| | Ex 6-P | Ex 7-P | Ex 8-P | Ex 9-P |
|---|---|---|---|---|
| Diimide | 50 | 70 | 50 | 50 |
| dicarboxylic | | | | |
| acid (mol %) | | | | |
| Imide | 1.44 | 1.74 | 1.47 | 1.38 |
| content | | | | |
| (mol/kg polyol) | | | | |
| Pre-made | — | — | — | — |
| imide acid | | | | |
| (g; mol) | | | | |
| Trimellitic | 151.55; 0.7888 | 216.98; 1.1293 | 169.20; 0.8806 | 185.80; 0.9670 |
| anhydride | | | | |
| (g; mol) | | | | |
| Ethylene | — | — | — | — |
| diamine | | | | |
| (g; mol) | | | | |
| 1,2-Bis(2- | 58.45; 0.3944 | 83.69; 0.5647 | — | — |
| aminoethoxy)ethane | | | | |
| (g; mol) | | | | |
| Dytek A | — | — | 51.17; 0.4403 | — |
| (g; mol) | | | | |
| Jeffamine D230 | — | — | — | 114.65; 0.4835 |
| (g; mol) | | | | |
| Phthalic | 58.41; 0.3944 | 35.85; 0.2420 | 65.22; 0.4403 | 71.62; 0.4835 |
| anhydride | | | | |
| (g; mol) | | | | |
| Polyethylene | 313.94; 1.5776 | 324.28; 1.6133 | 354.02; 1.7613 | 330.44; 1.6440 |
| glycol 200 | | | | |
| (g; mol) | | | | |
| Diethylene | — | 34.24; 0.3227 | — | 41.05; 0.3868 |
| glycol | | | | |
| (g; mol) | | | | |
| TYZOR AA105 | 0.1350; 0.1225 | 0.1490; 0.1526 | 0.1240; 0.1315 | 0.1414; 0.1526 |
| (g) | | | | |
| Make up | — | 11.15 | — | 13.11 |
| Diethylene | | | | |
| glycol | | | | |
| (g) | | | | |

TABLE 3

| | Ex 10-P | Ex 11-P | Ex 12-P | Ex 13-P |
|---|---|---|---|---|
| Diimide | 50 | 50 | 35 | 50 |
| dicarboxylic | | | | |
| acid | | | | |
| (mol %) | | | | |
| Imide | 1.45 | 1.47 | 1.08 | 1.46 |
| content | | | | |
| (mol/kg | | | | |
| polyol) | | | | |
| Pre-made | — | — | — | — |
| imide acid | | | | |
| (g; mol) | | | | |
| Trimellitic | 126.82; 0.6601 | 159.54; 0.8304 | 145.24; 0.7560 | 84.41; 0.4394 |
| anhydride | | | | |
| (g; mol) | | | | |
| Ethylene | — | — | — | — |
| diamine | | | | |
| (g; mol) | | | | |
| 1,2-Bis(2- | — | — | — | — |
| aminoethoxy)ethane | | | | |
| (g; mol) | | | | |
| Dytek A | — | — | — | — |
| (g; mol) | | | | |
| Jeffamine D230 | — | — | — | — |
| (g; mol) | | | | |
| 1,3-CHDMA | 46.95; 0.3300 | — | — | — |
| (g; mol) | | | | |
| 1,2-CHDA | — | 47.41; 0.4152 | — | — |
| (g; mol) | | | | |
| IPDA | — | — | 64.37; 0.3780 | — |
| (g; mol) | | | | |
| EGAPE | — | — | — | 38.72; 0.2197 |
| (g; mol) | | | | |
| Phthalic | 48.88; 0.3300 | 61.49; 0.4151 | 103.98; 0.7020 | 32.54; 0.2197 |
| anhydride | | | | |
| (g; mol) | | | | |
| Polyethylene | 262.72; 1.53202 | 333.81; 1.6607 | 369.03; 1.8360 | 150.13; 0.7469 |
| glycol 200 | | | | |
| (g; mol) | | | | |
| Diethylene | — | — | 57.30; 0.5400 | 13.99; 0.1318 |
| glycol | | | | |
| (g; mol) | | | | |
| TYZOR | 0.0942; 0.1067 | 0.1322; 0.1260 | 0.1401; 0.1504 | 0.0633; 0.0625 |
| AA105(g) | | | | |
| Make up | — | — | 11.64 | 4.60 |
| Diethylene | | | | |
| glycol(g) | | | | |

TABLE 4

| | | | | | OH #; | Acid # | Viscosity |
|---|---|---|---|---|---|---|---|
| | Tg | | | | theoretical | (mg | (Pa-s at |
| | (° C.) | Mn | Mw | PDI | (mg KOH/g) | KOH/g) | 25° C.) |
| Ex 1-P | −39 | 646 | 1081 | 1.67 | 197; 180 | 0.15 | 31.2 |
| Ex 2-P | −34 | 677 | 1243 | 1.84 | 176; 180 | 0.17 | 43.8 |
| Ex 3-P | −47 | 595 | 947 | 1.59 | 212; 199 | 1.40 | 6.2 |
| Ex 4-P | −32 | 760 | 1252 | 1.65 | 172; 164 | 0.47 | 283.0 |
| Ex 5-P | −44 | 719 | 1160 | 1.61 | 201; 181 | 0.54 | 8.83 |
| Ex 6-P | −38 | 717 | 1332 | 1.86 | 164; 161 | 0.56 | 18.2 |
| Ex 7-P | −41 | 621 | 1149 | 1.85 | 219; 195 | 0.24 | 16.6 |
| Ex 8-P | −43 | 728 | 1322 | 1.81 | 174; 165 | 0.25 | 30.9 |
| Ex 9-P | −40 | 790 | 1344 | 1.70 | 186; 171 | 0.64 | 18.1 |
| Ex 10-P | −36 | 771 | 1360 | 1.76 | 163; 163 | 0.54 | 99.6 |
| Ex 11-P | −34 | 684 | 1225 | 1.79 | 164; 165 | 0.94 | 63.7 |
| Ex 12-P | −51 | 680 | 1083 | 1.59 | 223; 208 | 0.44 | 21.8 |
| Ex 13-P | −42 | 794 | 1392 | 1.75 | 168; 164 | 0.06 | 18.9 |

The data of Table 4 illustrate that each of Ex 1-P to Ex 13-P had a Tg less than or equal to −20° C.; each of Ex 1-P to Ex 13-P had less than or equal to 300 Pa·s at 25° C.; a number average molecular weight (Mn) less than or equal to 1,500 g/mol; and a hydroxyl number from 100-350 KOH/g.

Foams (Ex 1-F through Ex 17-F, and Comp Ex A-F through Comp Ex C-F) were made from formulations as set forth in Tables 5, 6, 7, 10, and 13. For each foam, the polyols, surfactant, water, and catalysts were combined using a laboratory mixer. The imide-modified polyol composition was placed in an oven at 70° C. overnight and then mixed with other polyols at room temperature while it was still warm and then cooled to room temperature (18-25° C.). The physical blowing agent (pentane mixture or SOLSICE LBA) was then mixed in, followed by the polyisocyanate. The resulting reaction mixture was mixed at high speed for 5 seconds and then immediately poured into a vertically oriented 30 cm×20 cm×5 cm mold (preheated to 55° C.). The reaction mixture reacted in the mold for 20 minutes, at which time the resulting foam was demolded.

Polyol A is an aromatic polyester polyol having a functionality of 2.0 and a hydroxyl number of 220 mg KOH/g.

Polyol B is an aromatic polyester polyol having a functionality of 2.4 and a hydroxyl number of 315 mg KOH/g.

Polyol C is polyethylene glycol 200.

Triethyl phosphate is a flame retardant. The urethane catalyst is a commercially available 1,1,4,7,7-pentamethyldiethylenetriamine product. The trimerization catalyst is a commercially available material, DABCO K2097, available from Evonik. The pentane blend is an 80/20 mixture of cyclopentane and isopentane. The silicone surfactant is commercially available as VORASURF SF 2937. The PMDI is a polymeric MDI product having an average isocyanate functionality of 3.0 and an isocyanate equivalent weight of 136.5. A number of properties were determined for the foam. The results are reported in Tables 8, 9, 11, 12, and 14.

Cream time and gel time were determined according to the testing procedure described in ASTM D7487 (2013). Cream time was observed visually; gel time was evaluated by touching the surface of the curing reaction mixture periodically with a wood tongue depressor (The gel time was the time after the polyisocyanate and formulated polyol composition are mixed at which strings begin to form when the wood tongue depressor was pulled away); tack-free time was the time at which the surface of the foam is no longer tacky to the touch; free rise foam density was measured according to ASTM D 6226;

Specimens of the fresh foam were conditioned overnight in room temperature air before being taken for property testing. K-Factor (thermal conductivity) was measured according to ASTM C518; foam core density was determined by weighing the K-factor testing specimen and measuring the physical dimension of the K-factor board. Compressive strength was measured according to ASTM D1621.

TABLE 5

| | Ex 1-F | Ex 2-F | Ex 3-F | Ex 4-F | Ex 5-F |
|---|---|---|---|---|---|
| | Parts | Parts | Parts | Parts | Parts |
| Polyol B | 20.2 | 20.2 | 20.2 | 20.2 | 20.2 |
| Imide- | 61 (Ex | 61 (Ex | 61 (Ex | 61 (Ex | 61 (Ex |
| modified | 1-P) | 2-P) | 3-P) | 4-P) | 5-P) |
| polyol | | | | | |
| composition | | | | | |
| Triethyl | 15 | 15 | 15 | 15 | 15 |
| phosphate | | | | | |
| Trimerization | 1.8 | 1.8 | 1.8 | 1.8 | 1.8 |
| Catalyst | | | | | |
| Urethane | 0.95 | 0.95 | 0.95 | 0.95 | 0.95 |
| Catalyst | | | | | |
| Silicone | 3 | 3 | 3 | 3 | 3 |
| surfactant | | | | | |
| Pentane | 17 | 17 | 17 | 17 | 17 |
| blend | | | | | |
| Water | 0.8 | 0.8 | 0.8 | 0.8 | 0.8 |
| Total from | 119.75 | 119.75 | 119.75 | 119.75 | 119.75 |
| B-side | | | | | |
| Polymeric | 250 | 250 | 250 | 250 | 250 |
| MDI | | | | | |
| Isocyanate | 440 | 465 | 423 | 470 | 435 |
| index | | | | | |

TABLE 6

| | Ex 6-F | Ex 7-F | Ex 8-F | Ex 9-F |
|---|---|---|---|---|
| | Parts | Parts | Parts | Parts |
| Polyol B | 20.2 | 20.2 | 20.2 | 20.2 |
| Imide- | 61 (Ex | 61 (Ex | 61 (Ex | 61 (Ex |
| modified | 6-P) | 7-P) | 8-P) | 9-P) |
| polyol | | | | |
| composition | | | | |
| Triethyl | 15 | 15 | 15 | 15 |
| phosphate | | | | |
| Trimerization | 1.8 | 1.8 | 1.8 | 1.8 |
| Catalyst | | | | |
| Urethane | 0.95 | 0.95 | 0.95 | 0.95 |
| Catalyst | | | | |
| Silicone | 3 | 3 | 3 | 3 |
| surfactant | | | | |
| Pentane | 17 | 17 | 17 | 17 |
| blend | | | | |
| Water | 0.8 | 0.8 | 0.8 | 0.8 |
| Total from | 119.75 | 119.75 | 119.75 | 119.75 |
| B-side | | | | |
| Polymeric | 250 | 250 | 250 | 250 |
| MDI | | | | |
| Isocyanate | 480 | 415 | 467 | 453 |
| index | | | | |

TABLE 7

| | | | | Comp Ex |
|---|---|---|---|---|
| | Ex 10-F | Ex 11-F | Ex 12-F | A-F |
| | Parts | Parts | Parts | Parts |
| Polyol A | — | — | — | 61 |
| Polyol B | 20.2 | 20.2 | 20.2 | 20.2 |
| Imide- | 61 (Ex | 61 (Ex | 61 (Ex | — |
| modified | 10-P) | 11-P) | 12-P) | |
| polyol | | | | |
| composition | | | | |
| Triethyl | 15 | 15 | 15 | 15 |
| phosphate | | | | |
| Trimerization | 1.8 | 1.8 | 1.8 | 1.8 |
| Catalyst | | | | |
| Urethane | 0.95 | 0.95 | 0.95 | 0.95 |
| Catalyst | | | | |
| Silicone | 3 | 3 | 3 | 3 |
| surfactant | | | | |
| Pentane | 17 | 17 | 17 | 17 |
| blend | | | | |
| Water | 0.8 | 0.8 | 0.8 | 0.8 |
| Total from | 119.75 | 119.75 | 119.75 | 119.75 |
| B-side | | | | |
| Polymeric | 250 | 250 | 250 | 250 |
| MDI | | | | |
| Isocyanate | 480 | 480 | 415 | 415 |
| index | | | | |

TABLE 8

| | | | Tack | Foam |
|---|---|---|---|---|
| | Cream | Gel | Free | Core |
| | Time | Time | Time | Density |
| | (s) | (s) | (s) | (g/L) |
| Ex 1-F | 8 | 35 | 81 | 43.5 |
| Ex 2-F | 9 | 40 | 85 | 42.8 |
| Ex 3-F | 10 | 47 | 140 | 43.2 |
| Ex 4-F | 7 | 37 | 90 | 42.3 |
| Ex 5-F | 7 | 35 | 75 | 43.7 |
| Ex 6-F | 8 | 36 | 100 | 42.3 |
| Ex 7-F | 8 | 36 | 120 | 43.2 |
| Ex 8-F | 7 | 32 | 110 | 42.5 |
| Ex 9-F | 7 | 32 | 65 | 42.7 |
| Ex 10-F | 6 | 34 | 90 | 43.2 |
| Ex 11-F | 8 | 39 | 100 | 42.3 |
| Ex 12-F | 8 | 31 | 75 | 42.9 |
| Comp Ex | 10 | 37 | 76 | 43.2 |
| A-F | | | | |

TABLE 9

| | | Compressive | | NBS Smoke |
|---|---|---|---|---|
| | K-factor at | strength, | NBS | mass |
| | 10° C. | z axis | Smoke | loss |
| | (mW/m-K) | (KPa) | D_{s max} | (wt %) |
| Ex 1-F | 19.1 | 159 | 35 | 22.3 |
| Ex 2-F | 19.2 | 130 | 33 | 22.2 |
| Ex 3-F | 19.5 | 125 | 35 | 21.8 |
| Ex 4-F | 19.0 | 119 | 31 | 21.3 |
| Ex 5-F | 19.0 | 123 | 36 | 22.5 |
| Ex 6-F | 19.1 | 121 | 29 | 23.1 |
| Ex 7-F | 18.9 | 116 | 34 | 22.7 |
| Ex 8-F | 19.2 | 100 | 34 | 23.3 |
| Ex 9-F | 18.8 | 106 | 33 | 21.5 |
| Ex 10-F | 18.8 | 147 | 36 | 22.5 |
| Ex 11-F | 18.8 | 129 | 33 | 23.6 |
| Ex 12-F | 19.2 | 112 | 58 | 25.2 |
| Comp Ex | 19.9 | 132 | 37 | 23.2 |
| A-F | | | | |

The data of Tables 8 and 9 illustrate advantageous ternal insulation performance properties while maintaining desirable fire performance properties. The data of Tables 8 and 9 illustrate desirable mechanical properties. Additionally, the data of Table 9 illustrate a decrease in k-factor for each of Ex 1-F to Ex 12-F, as compared to Comp Ex A-F.

TABLE 10

| | | | | | Comp Ex |
|---|---|---|---|---|---|
| | Ex 13-F | Ex 14-F | Ex 15-F | Ex 16-F | B-F |
| | Parts | Parts | Parts | Parts | Parts |
| Polyol A | — | — | — | — | 52.4 |
| Polyol B | 20.2 | 20.2 | 20.2 | 20.2 | 20.2 |
| Polyol C | 8.6 | 8.6 | 8.6 | 8.6 | 8.6 |
| Imide- | 52.4 (Ex | 52.4 (Ex | 52.4 (Ex | 52.4 (Ex | — |
| modified | 6-P) | 8-P) | 10-P) | 11-P) | |
| polyol | | | | | |
| composition | | | | | |
| Triethyl | 15 | 15 | 15 | 15 | 15 |
| phosphate | | | | | |
| Trimerization | 1.8 | 1.8 | 1.8 | 1.8 | 1.45 |
| Catalyst | | | | | |
| Urethane | 0.95 | 0.95 | 0.95 | 0.95 | 0.75 |
| Catalyst | | | | | |
| Silicone | 3 | 3 | 3 | 3 | 3 |
| surfactant | | | | | |
| Pentane | 17 | 17 | 17 | 17 | 17 |
| blend | | | | | |
| Water | 0.8 | 0.8 | 0.8 | 0.8 | 0.8 |
| Total from | 119.75 | 119.75 | 119.75 | 119.75 | 119.2 |
| B-side | | | | | |
| Polymeric | 250 | 250 | 250 | 250 | 250 |
| MDI | | | | | |
| Isocyanate | 415 | 405 | 415 | 415 | 370 |
| index | | | | | |

TABLE 11

| | | | Tack | Foam |
|---|---|---|---|---|
| | Cream | Gel | Free | Core |
| | Time | Time | Time | Density |
| | (s) | (s) | (s) | (g/L) |
| Ex 13-F | 9 | 32 | 95 | 43.6 |
| Ex 14-F | 7 | 28 | 80 | 43.5 |
| Ex 15-F | 9 | 33 | 110 | 42.9 |
| Ex 16-F | 9 | 40 | 100 | 42.8 |
| Comp Ex | 7 | 26 | 90 | 45.4 |
| B-F | | | | |

TABLE 12

| | | | | NBS | |
|---|---|---|---|---|---|
| | | Compressive | NBS | Smoke | |
| | K-factor | strength, | Smoke | mass | Adhesion |
| | at 10° C. | z axis | Ds | loss | to metal |
| | (mW/m-K) | (KPa) | max | (wt %) | substrate |
| Ex 13-F | 19.2 | 141 | 33 | 21.4 | Good |
| Ex 14-F | 19.2 | 128 | 39 | 22.3 | — |
| Ex 15F | 19.0 | 116 | 40 | 22.8 | — |
| Ex 16-F | 19.4 | 121 | 37 | 23.6 | Good |
| Comp Ex | 20.0 | 195 | 53 | 22.1 | Fair |
| B-F | | | | | |

TABLE 13

| | Comp Ex | |
|---|---|---|
| | C-F | Ex 17-F |
| | Parts | Parts |
| Polyol A | 61 | |
| Polyol B | 20.2 | 20.2 |
| Imide-modified | | 61 (Ex |
| polyol composition | | 4-P) |
| Triethyl phosphate | 15 | 15 |
| Trimerization Catalyst | 1.8 | 1.8 |
| Urethane Catalyst | 0.95 | 0.95 |
| Silicone surfactant | 3 | 3 |
| Solstice LBA | 31.7 | 31.7 |
| Water | 0.8 | 0.8 |
| Total from B-side | 134.45 | 134.45 |
| Polymeric MDI | 250 | 250 |
| Isocyanate index | 415 | 470 |

TABLE 14

| | | | Tack | Foam | |
|---|---|---|---|---|---|
| | Cream | Gel | Free | Core | K-factor |
| | Time | Time | Time | Density | at 10° C. |
| | (s) | (s) | (s) | (g/L) | (mW/m-K) |
| Ex 17-F | 7 | 43 | 85 | 43.4 | 17.3 |
| Comp Ex | 8 | 41 | 95 | 45.1 | 18.3 |
| C-F | | | | | |

The data of Tables 11 and 12 illustrate advantageous thermal insulation performance properties while maintaining desirable fire performance properties. The data of Tables 11 and 12 illustrate desirable mechanical properties. Additionally, the data of Table 12 illustrate a decrease in k-factor for each of Ex 13-F to Ex 16-F, as compared to both Comp Ex A-F and Comp Ex B-F.

The data of Table 14 illustrate advantageous thermal insulation performance properties. Additionally, the data of Table 14 illustrate a decrease in k-factor for Ex 17-F, as compared to Comp Ex C-F.

1. A method of making an imide-modified polyol composition, the method comprising:
a) forming one or more imide group-containing compounds having terminal carboxylic acid groups by reacting trimellitic anhydride with an aliphatic diamine in the presence of 0 to 3 parts by weight of another carboxylic acid anhydride and/or a polycarboxylic acid per 100 parts by weight of the trimellitic anhydride;
b) optionally combining the one or more imide group-containing compounds having terminal carboxylic acid groups with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters, wherein the mole ratio of the imide group-containing compounds and the aromatic dicarboxylic acid derivatives is at least 25:75;
c) then esterifying the one or more imide group-containing compounds having terminal carboxylic acid groups and the one or more aromatic carboxylic acid derivatives if present by reaction with one or more polyols having a hydroxyl equivalent weight of 30 to 500 g/equivalent,
wherein the imide-modified polyol composition has an acid number of no greater than 5 mg KOH/gram, has a hydroxyl number of 100 to 350 mg KOH/g and contains 0.65 to 2.30 moles of imide groups per kilogram of imide-modified polyol composition.

2. The method of claim 1 wherein the aliphatic diamine is selected from 1,2-ethanediamine, 2,2′-(ethylenedioxy)bis(ethylamine), 3,3′-[1,2-ethanediylbis(oxy)]bis-1-propanamine, α-(2-aminomethylethyl)-ω-(2-aminomethylethoxy)-poly[oxy(methyl-1,2-ethanediyl)], 2-methyl-1,5-pentanediamine, 1,3-cyclohexanedimethanamine, 1,2-cyclohexanediamine, 5-amino-1,3,3-trimethyl-cyclohexanemethanamine, including conformational and positional isomers, or combinations thereof.

3. The method of claim 1 wherein at least 50% by weight of the one or one or more polyols having a hydroxyl equivalent weight of 30 to 500 g/equivalent have a hydroxyl equivalent weight of 95 to 500.

4. The method of claim 1 wherein a) is performed in the presence of the one or more polyols having a hydroxyl equivalent weight of 30 to 500 g/equivalent and in the absence of a catalytic amount of an esterification catalyst.

5. The method of claim 1 wherein b) is not performed, and a product obtained in c) is combined with one or more aromatic dicarboxylic acid derivatives that contain no imide groups selected from aromatic carboxylic acid anhydrides, aromatic dicarboxylic acids, aromatic dicarboxylic acid halides, and aromatic dicarboxylic acid dialkyl esters and the resulting combination is subjected to esterification and/or transesterification conditions to produce the imide-modified polyol composition.

6. The method of claim 1 wherein b) is performed, the imide-modified polyol composition is obtained in c) and the imide-modified polyol composition comprises a mixture of an imide-modified polyol and a polyester polyol corresponding to an esterification product of the one or more aromatic dicarboxylic acid derivatives and the one or more polyols having a hydroxyl equivalent weight of 30 to 500 g/equivalent.

7. An imide-modified polyol composition produced in the process of claim 1.

8. The imide-modified polyol composition of claim 7, which comprises a mixture of an imide-modified polyol and a polyester polyol corresponding to an esterification product of the one or more aromatic dicarboxylic acid derivatives and the one or more polyols having a hydroxyl equivalent weight of 30 to 500 g/equivalent.

9. A method for preparing a rigid isocyanate-based foam, comprising forming a reaction mixture and reacting the reaction mixture to produce the rigid isocyanate-based foam, wherein the reaction mixture comprises
a) at least one aromatic polyisocyanate in an amount to provide an isocyanate index of 100 to 600;
b) polyols, wherein the polyols include at least 25% by weight of the imide-modified polyol composition of claim 7 or 8 and 0 to 75% by weight of one or more non-imide-modified polyols, and wherein the imide content of the polyols is 0.125 to 1.75 moles of imide groups per kilogram;
c) at least one blowing agent;
d) at least one halogenated and/or phosphorus-containing flame retardant;
e) at least one foam-stabilizing surfactant; and
f) at least one urethane and/or isocyanate trimerization catalyst.
